(19) United States
(12) Patent Application Publication
(10) Pub. No.: US 2003/0219253 A1
(43) Pub. Date: Nov. 27, 2003

(54) Proactive techniques for sustenance of high-speed fixed wireless links

(75) Inventors: Vikas Kukshya, Calabasas, CA (US); Hossein Izadpanah, Newbury Park, CA (US)

Correspondence Address: Ross A. Schmitt, ESQ., c/o LADAS & PARRY, Suite 2100, 5670 Wilshire Boulevard, Los Angeles, CA, 90036-5679, US

(73) Assignee: HRL Laboratories, LLC

(21) Appl. No.: 10/438,418

(22) Filed: May 13, 2003

Related U.S. Application Data
(60) Provisional application No. 60/399,657, filed on Jul. 29, 2002.
(60) Provisional application No. 60/382,683, filed on May 21, 2002.

(51) Int. Cl. H04B 10/00

(52) U.S. Cl. 398/118; 398/1

(57) ABSTRACT

An apparatus and method for proactively identifying and initiating corrective actions for restoration of a primary wireless data link during adverse operation conditions. The scheme imparts dynamic adaptability to the wireless link architecture and can ensure overall wireless link availability of better than 99.999%.

### CROSS REFERENCE TO RELATED APPLICATIONS

This application claims the benefit of U.S. Provisional Application 60/399,657 filed Jul. 29, 2002 and U.S. Provisional Application 60/382,683 filed May 21, 2002, the disclosures of which are hereby incorporated herein by reference.

The present document is related to (i) a commonly assigned U.S. Provisional Patent Application entitled “Method and Apparatus for Load Switching in Hybrid RF/Free Space Optical Wireless Links” Serial No. 60/399,659, filed Jul. 29, 2002 and its subsequent U.S. Non-Provisional Patent Application Serial No.______filed______and (ii) to a commonly assigned U.S. Non-Provisional Patent Application entitled “Hybrid RF and Optical Wireless Communication Link and Network Structure Incorporating It Therein” Serial No. 09/800,917 filed on Mar. 5, 2001. The contents of the related applications filed Jul. 29, 2002 and Mar. 5, 2001 are hereby incorporated by reference herein.

### BACKGROUND OF THE INVENTION

1. Field of the Invention

The present invention relates Free Space Optical Wireless (FSOW) links. Specifically, the present invention relates to a proactive scheme to identify and initiate in real-time corrective actions for restoration of FSOW link performance during adverse operating conditions.

2. Description of Related Art

A few years ago, the computers were shipped with less than one Giga byte of hard disk memory whereas today even a 10 Giga byte hard disk memory barely seems adequate. The fact is that our appetite for data has grown, and will continue to grow, especially with the proliferation of Internet and Internet based data/multimedia applications. Today, the sluggish dial-up connections are rapidly being replaced by high-speed, always-on, wired data access connections, but the existing copper/fiber backbone infrastructure can support only so many connections before getting weighed down. There is a need to design and deploy new high-capacity, high-speed backbone as well as last-mile data access and distribution networks.

Wireless technologies appear to be better solutions, as compared to the contemporary wired technologies, in terms of deployment costs, regulatory restrictions and process-related time-constraints. Free Space Optics (FSO) is one of the promising Line-Of-Sight (LOS) high-speed and extremely secure wireless technologies that can facilitate realization of next-generation carrier-grade, high-reliability backbone and last-mile networks in an inexpensive, yet timely, manner. However, FSO not sufficiently robust to do it alone. The performance of FSO links can be severely affected during adverse weather conditions. The biggest challenge is moderate-to-dense fog conditions. While, excessive scattering due to dust particles, heavy rain, or snow can also possibly disrupt the service, fog is a much bigger issue because the tiny fog particles not only scatter and distort the signal, but also absorb the energy significantly. In some cases the overall signal attenuation can be as high as 300 dB/km. In addition to adverse weather conditions, random air turbulence due to temperature differentials between atmospheric layers can also affect the performance in some cases, though not significantly.

What is needed is an improved design and development of extremely robust and high-speed communication links, including FSOW communication links, for Next Generation Internet (NGI) systems. The FSOW links, capable of up to multi-Gbps, can be extremely secure and may serve as an excellent solution to rapidly deployable high-speed military communication systems, e-commerce and banking applications. However, as mentioned above FSOW links are also highly susceptible to adverse weather conditions such as dense fog, heavy rain, etc. and must be protected to prevent frequent outages. For the applications mentioned above, data link availability statistics must be better than 99.999%. The present invention provides proactive schemes that can facilitate high data link availability over extended periods of time.

Presently, research is being preformed in the area of improved communication systems. For example, U.S. Pat. No. 5,946,120 discloses a hybrid optical and RF communication system wherein the RF signal is used to provide a timing base for the digital pulses carried by the optical signal. The receiver control unit uses the same for synchronization and reconstruction of optical signals. In addition, U.S. Pat. No. 6,122,084 discloses the use of the primary single-wavelength optical communication beam for automatic gain control of the received signal to facilitate constant amplitude signals at the detector. The apparatus includes optical input signal level sensor and optical attenuator. The received signal levels are measured at the input (of the receiver) and the optical detector in the receive circuitry. These signals are compared to generate a control signal that controls attenuation of the optical beam before the detector. Further, U.S. Pat. No. 6,031,648 describes the use of a two-wavelength optical communication system in which one of the wavelengths is used as a pilot signal for automatic gain control functionality. The attenuation of the pilot signal quantifies and controls the amplification/gain for the communication beam. Finally, U.S. Pat. No. 5,678,198 discloses pre-transmission and post-transmission control/processing units for signal conditioning and consequently increasing the dynamic range of the system. The system aims to maintain a constant overall system gain.

Currently, broadband communication systems do not employ continuous real-time link monitoring and proactive corrective schemes to prevent wireless link outages. Most systems have extra power margins, which are static, built-in margins to mitigate moderate increases in atmospheric attenuation levels. Current FSOW communication systems do not employ dynamic power control, dynamic data rate control, multi-hop routing or dynamic load sharing between FSOW and RF wireless links. The present invention solves many of the above problems by efficiently integrating all the above mentioned techniques to facilitate proactive adapting to operating conditions. In addition, instead of solely using a Received Signal Strength Indicator (RSSI) to perform real-time wireless channel characterization, end-to-end bit error rate (BER) statistics are preferably used to govern the decision making process.

### SUMMARY OF THE INVENTION

This invention proposes a proactive scheme to identify and initiate in real-time corrective actions for restoration of wireless link performance during adverse operating conditions.

In one embodiment the present invention provides for an apparatus for proactively sustaining a wireless link comprising: a primary wireless data link; a wireless control link; and a wireless link maintenance sub-system including a processor for maintaining the primary wireless data link by monitoring a set of parameters associated with the wireless control link, wherein the wireless link maintenance sub-system utilizes the monitored parameters associated with the wireless control link to proactively evaluate a set of possible actions, and select the best action from the set of possible actions.

In another embodiment the present invention provides for a method for maintaining a wireless connection comprising the steps of: monitoring a set of performance parameters of a wireless control link; evaluating a set of possible actions based on said set of performance parameters; and implementing on a wireless primary data link a best action from said set of possible actions.

In yet another embodiment the present invention provides an apparatus for sustaining fixed wireless links during varying channel conditions, the apparatus comprising: an input for receiving link-performance information regarding at least one control link; a data processing system for receiving the link-performance information from the input and for processing the link-performance information to determine at least one data link adjustment for adjusting parameters of at least one data link based on the performance information; and an output for outputting the data link adjustment for use in adjusting the parameters of the data link.

### BRIEF DESCRIPTION OF THE DRAWINGS

FIG. 1 depicts one embodiment of the present invention with separate wireless control link and primary wireless data link;

FIG. 2 depicts measured BER performance of both a wireless control link and a primary wireless data link under nominal conditions;

FIG. 3 depicts measured BER performance of both a wireless control link and a primary wireless data link under adverse conditions;

FIG. 4a shows measured BER and RSSI data from 12:00 to 24:00;

FIG. 4b shows measured BER and RSSI data from 14:00 to 6:00;

FIG. 5 depicts experimental results of dynamic system power control;

FIG. 6 shows experimental results of dynamic rate control;

FIG. 7 is a block diagram of a second embodiment of the present invention;

FIG. 8 depicts one deployment scenario for the present invention; and

FIG. 9 depicts expected performance of a hybrid architecture.

### DETAILED DESCRIPTION OF THE PREFERRED EMBODIMENTS

The present invention now will be described more fully hereinafter with reference to the accompanying drawings, in which preferred embodiments of the invention are shown. This invention may be embodied in many different forms and should not be construed as limited to the embodiments set forth herein.

### Overview

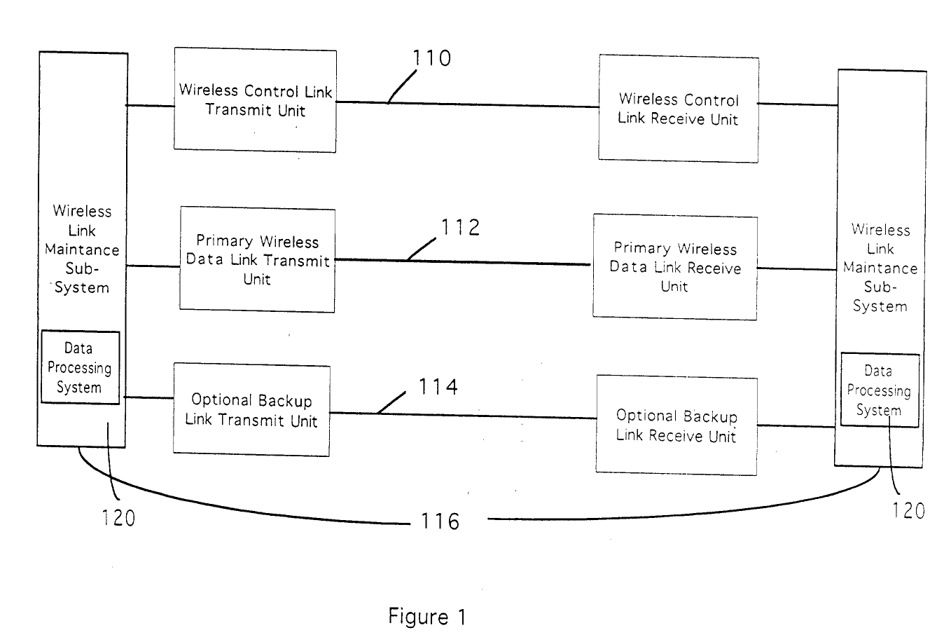

One embodiment of the present inventions as shown in FIG. 1, comprises a separate, independent, relatively low power, and low data rate wireless control link 110 in parallel with a high-margin primary wireless data link 112. Both wireless links, primary 112 and control 110, are preferably the same type of link, either Free Space Optical Wireless (FSOW) links or Radio Frequency (RF) links. In addition, both links, primary 112 and control 110, are preferably governed in real-time by a wireless link management sub-system 116. The wireless link management sub-system 116 is provided on both sides of the wireless control link 110 and the primary wireless data link 112. One part of the wireless link management sub-system 116 provides monitoring of the links in the upstream (transmitter to receiver) direction, while another part of the wireless link management sub-system 116 provides monitoring of the links in the downstream (receiver to transmitter) direction. One skilled in the art will appreciate that if the upstream and downstream links are equivalent, which is typically the case in a point-to-point system, the wireless link management sub-system 116 may optionally be located on only one side of the link. In this case, the wireless control link 110 will not only be used to monitor the parameters of the link but will also be used to transmit control information to the side not connected to the wireless link management sub-system 116.

The wireless link management sub-system 116 includes a data processing system 120 that preferably runs Wireless Cormectivity Management Software (WCMS). The wireless link management sub-system 116 preferably monitors continuously the bit-error rate (BER) performance of the wireless control channel 110 in real-time, optionally records system parameters, calculates desired performance metrics, optionally intelligently estimates link performance in the immediate near-future, evaluates possible corrective actions in the event of adverse channel conditions that may be caused by adverse weather events, optionally identifies the best corrective action and co-ordinates primary wireless data link performance restoration by changing characteristics associated with the primary wireless data link 112. By operating the wireless control link 110 with lower built-in margins as compared to the primary wireless data link 112, any relative performance deterioration can be identified significantly before the performance of primary wireless data link is affected. This allows the wireless primary data link 112 to dynamically adapt to higher margin levels and mitigate adversities in advance (before operating conditions deteriorate further) thereby significantly reducing the probability of an outage on the primary wireless data link 112. This dynamic adaptability, imparted to the wireless communication network by the proposed architecture, can ensure overall link availability statistics of better than 99.999% (while maximizing throughput at desired levels of performance even during adverse operating conditions).

The wireless link management sub-system 116 continuously monitors the wireless control link performance with reference to pre-defined performance metrics and Quality of Service (QoS) levels. In addition, to accurately characterize the real-time performance of the wireless control link 110, the wireless link management sub-system 116 optionally provides a forecast of the near-term performance of the link preferably based on past data values and weather parameters. One skilled in the art will appreciate that there are many performance parameters and environmental variables that could be used to provide the forecast. Based on the near-term forecasting, also referred to as “nowcasting,” the wireless link management sub-system 116 identifies a possible set of actions that can be initiated to further secure the primary wireless data link 112 from failure with respect to expected adversities. Some of the actions that can be implemented into the primary wireless data link 112 are: increasing the power in incremental steps, deploying more robust forward-error-correction techniques, multi-hop routing, modulation and data rate control, data traffic sharing and/or complete switching between different transport media, etc. One skilled in the art will appreciate that other actions could also be used. These actions can be implemented in a specific order depending upon the pre-defined wireless network priorities such as maximization of throughput, minimum end-to-end delay for real-time multimedia, etc. In any case, the wireless link management sub-system 116 identifies the most effective and efficient solution for a given operational scenario.

In addition to the wireless control link 110 and the primary wireless data link 112, an optional back-up link 114 may also be provided, as shown in FIG. 1. This optional back-up link 114 may be used to transfer some or all of the data that would normally be carried upon the primary wireless data link 112. A current trend is to adopt hybrid architectures that exploit the complimentary nature of FSO and RF wireless channels with respect to their individual weather sensitivities. The FSO links are highly susceptible to dense fog, mist and dust particles but are relatively less vulnerable to rain events. On the other hand, though the performance of RF systems can degrade significantly during rain events, especially at frequencies above 10 GHz, they are least susceptible to dust, mist or fog particulates. A Hybrid Architecture combines the FSO and RF technologies to improve the overall wireless channel reliability and availability statistics.

In one embodiment, FSOW links may be used for the primary wireless data link 112 and RF links may be utilized as the back-up link 114. This Hybrid Architecture combines the FSOW and RF technologies to improve the overall wireless channel reliability and availability statistics.

### The Hardware

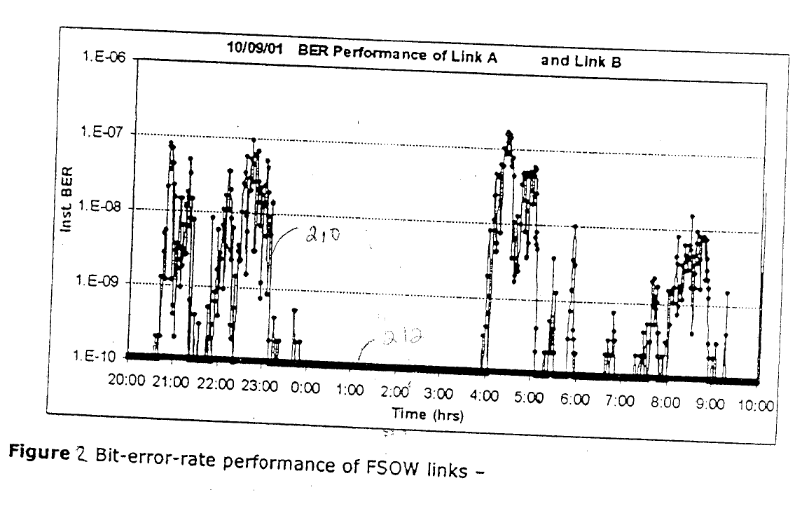

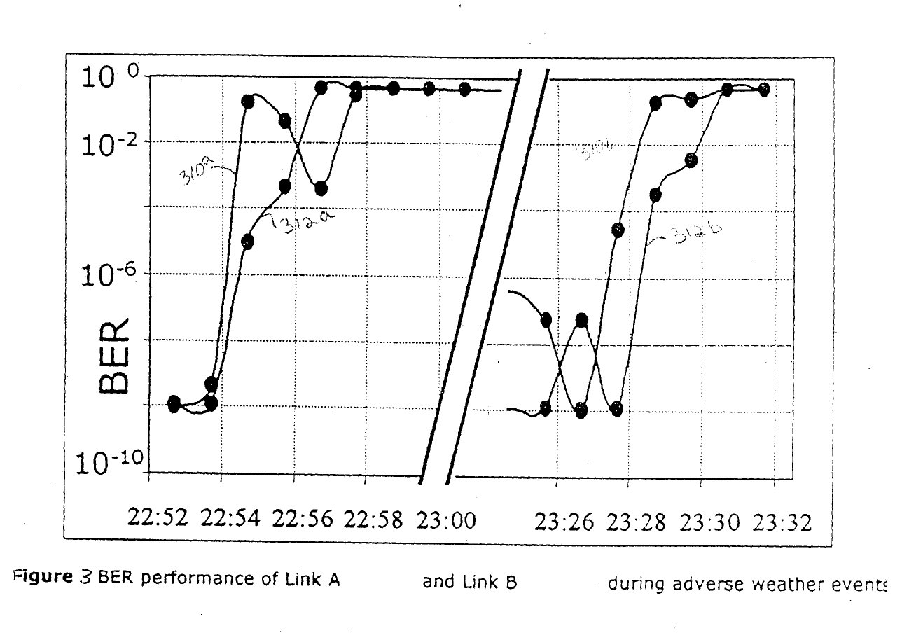

A system comprising a independent wireless control link 110 and primary wireless data link 112 was implemented and experimentally tested. This system comprised two FSOW links operating parallel to each other over a link length of about 500 meters. Both the links were operated at OC-3 data rates, but the wireless control link 110 (Link A) had a lower power margin as compared to the primary wireless data link 112 (Link B). Consequently, the wireless control link 110 was more sensitive to variations in atmospheric attenuation as shown in FIG. 2. During absolute clear-sky-conditions both links operated error-free at a bit-error-rate (BER) of about 10⁻¹⁰. However, any significant increase in atmospheric attenuation adversely affects the BER of the wireless links. FIG. 3 shows that the BER 210 (one minute intervals) for the wireless control link fluctuates between 10⁻¹⁰ and 10⁻⁷ intermittently during random atmospheric changes due to mild increase in attenuation levels. On the other hand, the BER 212 for the primary wireless data link maintains a consistent BER level of 10⁻¹⁰ despite of similar environmental/operating conditions.

During adverse weather conditions, the BER performance of the wireless control link 110 deteriorated faster as compared to that of the primary wireless data link 112. In other words, during adverse weather conditions, the wireless control link 110 breached the pre-identified (desirable minimum) QoS level before the primary wireless data link 112. This is explicitly shown in FIG. 3. FIG. 3 shows two instances when the wireless control link 310a, 310b breached the threshold QoS level (10⁻⁶) ahead of the primary wireless data link 312a, 312b during deteriorating weather conditions. In this particular example, the primary wireless data link 312a, 312b failed as much as 30 seconds to 1 minute after the failure of wireless control link 310a, 310b due to available extra margin.

In FIG. 3, the X axis represents time (marked at 2 minute intervals) and the Y axis represents (one-minute averaged) BER. As can be seen, at about 22:53, the weather conditions start deteriorating and the wireless control link 310a failed (it breached 10⁻⁶ level) at about 22:54. The primary wireless data link 312a however dis not fail until approximately 30 seconds later. The links restored as soon as the weather conditions improve. Again, at about 23:26, the atmospheric attenuation starts increasing and the wireless control link 310b failed at about 23:27. The primary wireless data link 312b follows suit and failed after one minute at 23:28.

Therefore, as mentioned above a lower margin wireless control link 110 (or the wireless control link that is being operated at a lower protection level than the primary wireless data link) can successfully identify potential outages in advance of a failure of a primary wireless data link 112. The wireless link management sub-system 116 can monitor link parameters from the wireless control link 110 and initiate sets of decision making and corrective actions to protect the primary wireless data link 112 from outage. In this experiment, the wireless link management sub-system 116 would have had a lead time of 30 seconds and 1 minute respectively during two adverse weather events. As one skilled in the art will appreciate the interval between the failure of the wireless control link and the failure of the primary wireless data link can be increased by careful design, calibration and accurate mapping.

### Software

As mentioned above BER measurements may be used to determine link parameters. In this embodiment, during clear-sky conditions, the primary wireless data link 112 is operated with a decent power margin to mitigate random atmospheric attenuation variations, and the wireless control link 116 is operated with bare minimum power to maintain the desired Quality of Service (QoS) level. One skilled in the art will appreciate that the primary 112 and control 110 wireless links can be accurately mapped to operate at the same QoS levels despite of different data rates and power levels. The result is any degradation in the performance of the wireless control link 110 can be measured and used to accurately predict the corresponding deterioration in the performance of the primary wireless data link 116. Such an accurate one-to-one mapping consequently obviates the need for expensive and bandwidth-inefficient performance monitoring of the wireless primary data link 116. The performance metric for the wireless control link 112 may include one parameter such as the end-to-end average bit error rate (BER) or a combination of several parameters such as received signal strength (RSS), BER, end-to-end delay etc depending upon the nature of data traffic and desired QoS levels.

The wireless link maintenance sub-system 116 monitors the performance of the wireless control link 110 continuously on a real-time basis. Thus, when degradation to the wireless control link 110 occurs, the wireless link maintenance sub-system 116 immediately initiates elaborate measures aimed at protecting the primary wireless data link 112 performance in near-future. In this manner, the primary wireless data link 112 which is unaffected by current deterioration in the weather/operating conditions due to built-in power margins, can proactively adapt to successfully mitigate any further deterioration in weather/operating conditions. The proactive dynamic adaptability thus helps in avoiding outages by taking corrective measures in advance and consequently ensures all-weather connectivity.

There are a number of schemes that can be exploited to introduce dynamic adaptability into the present system The system should not only be able to adapt to changing channel conditions and maintain sustained end-to-end connectivity, but also ensure desired level of QoS. Some of the possible techniques that can provide the desired adaptability that may be implemented by the wireless link maintenance sub-system 116 are as follows:

1. Dynamic Power Control—The transmit power can be increased to mitigate atmospheric attenuation during channel changes which may be caused by adverse weather conditions. This can be implemented such that the transmit power increases incrementally in moderate steps to ensure high functional and power efficiency.

2. Dynamic Data Rate Control—The data rate on the primary wireless data link 112 can be dynamically changed in response to the changing channel conditions. During adverse operating conditions, the data rates can be reduced in pre-defined steps to improve/maintain the link QoS. For example, data rates on the primary wireless data link 112 can be reduced from OC-48 to OC-24 and further down to OC-12 with successive increase in atmospheric attenuation levels.

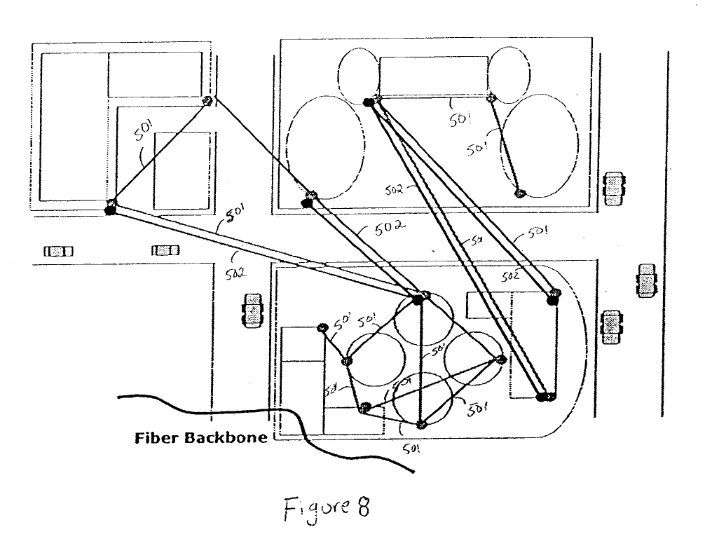

3. Dynamic Data Routing—In the event of primary wireless data link 112 outage scenarios, dynamic data routing can be initiated. Instead of routing the data traffic over longer primary wireless data links, the data could be sent to the destination over a number of shorter primary wireless data links. Shorter primary wireless data links, as mentioned above, are less prone to outage due to hefty built-in margins and thus can continue to function normally even when longer primary wireless data links experience outage. Though this scheme can ensure sustained end-to-end' connectivity, it introduces delay in to the system. This concept of shorter and longer data links will be discussed further in relation to FIG. 8.

The following section is an example scenario and the step-by-step execution of the wireless link management sub-system 116 based on the independent wireless control link performance. One skilled in the art will appreciate that the ‘power values’ in the following example have been chosen to better explain the overall functionality, and are not indicative of actual power levels. Further, while all the decisions are based on BER, other performance metrics may be used.

The wireless control link 110 is operating at 20 dBm and is supporting a data rate of OC-3 while the primary wireless data link 112 is operating at 100 dBm and is supporting a data rate of OC-12. The threshold power level for OC-12 functionality at the desired level of QoS (or BER performance level) is 50 dBm.

The atmospheric attenuation increases and the received signal levels for the wireless control link 110 and the primary wireless data link 112 fall by 15 dBm. The BER level of the wireless control link 110 increases (performance degrades) since there is no built-in margin but the BER of the primary wireless data link 112 remains unaffected due to the built-in margin. Though the primary wireless data link 112 was not able to detect any change in the atmospheric conditions, the wireless control link 110 (being more sensitive due to no built-in margin) detects the change and the governing wireless link management sub-system 116 increments the power level of the primary wireless data link 110 by 35 dBm to compensate for future degradation. The primary wireless data link 112 is now operating at 100−15+35=120 dBm. This is commonly referred to as dynamic power control. Instead of running the primary wireless data link 112 at 120 dBm all the time to account for worst case scenario, the power level is increased from 100 dBm to 200 dBm only when required.

If weather conditions deteriorate further, the wireless link maintenance sub-system 116 proactively reduces the data rate of the primary wireless data link 112 from OC-12 to OC-9 to compensate for increased attenuation and maintain the desired level of QoS (BER performance). The data rates can be further reduced from OC-9 to OC-3 in small steps, if necessary. This is commonly referred to as dynamic data rate control.

If the system includes the optional backup link, such as an RF link and if the operating conditions deteriorate significantly, the wireless link maintenance sub-system 116 may activate the hybrid architecture and transfer part of the traffic through RF links.

The reference performances of the control and primary links can be accurately mapped relative to each other and successive margin levels along with corresponding corrective actions can be defined in the wireless link maintenance sub-system 116 to impart the desired proactive functionality. With the embodiment of FIG. 1, several possible corrective actions, for a given operational scenario, can be evaluated real-time on the wireless control link 110 before actual implementation onto the primary wireless data link 112.

### Performance Metrics

As mentioned above, in one embodiment the wireless link maintenance sub-system 116 utilizes BER data to evaluate the end-to-end performance statistics of the wireless link. While Received Signal Strength Indicator (RSSI) can be an excellent measure of end-to-end performance statistics for an optical fiber or any other controlled environment, the same is not true for FSOW links. To date no one has established a definitive relationship between wireless RSSI, including free-space optical RSSI, and BER performance for all random atmospheric changes, or model all the possible weather/operational scenarios and their effects on RSSI and BER. Therefore, simply using RSSI to measure the end-to-end performance statistics for a wireless link may result in errors in determining actions to be taken to prevent the wireless link from failing, essentially exceeding a given BER.

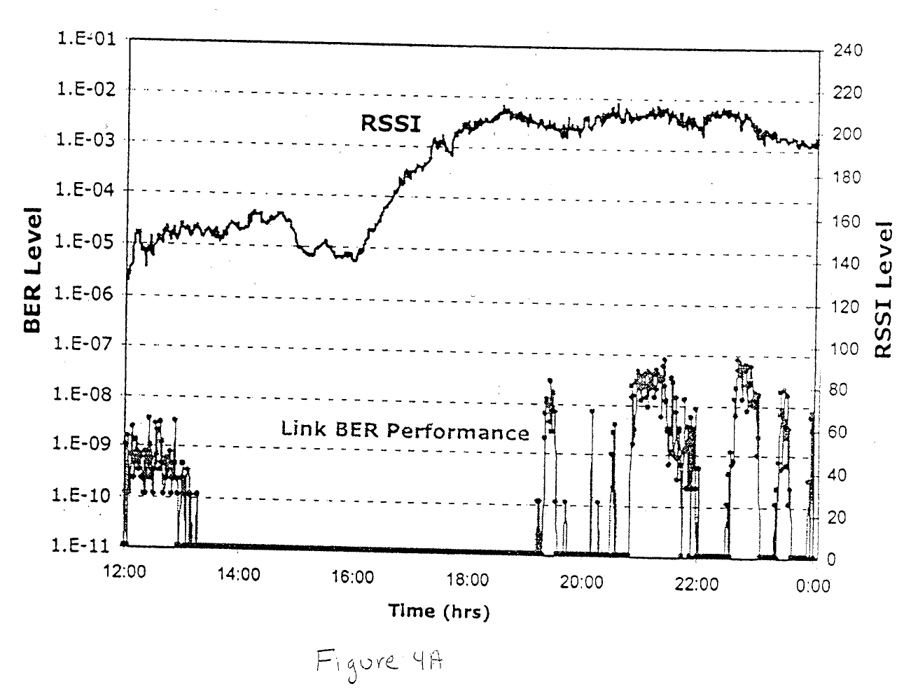

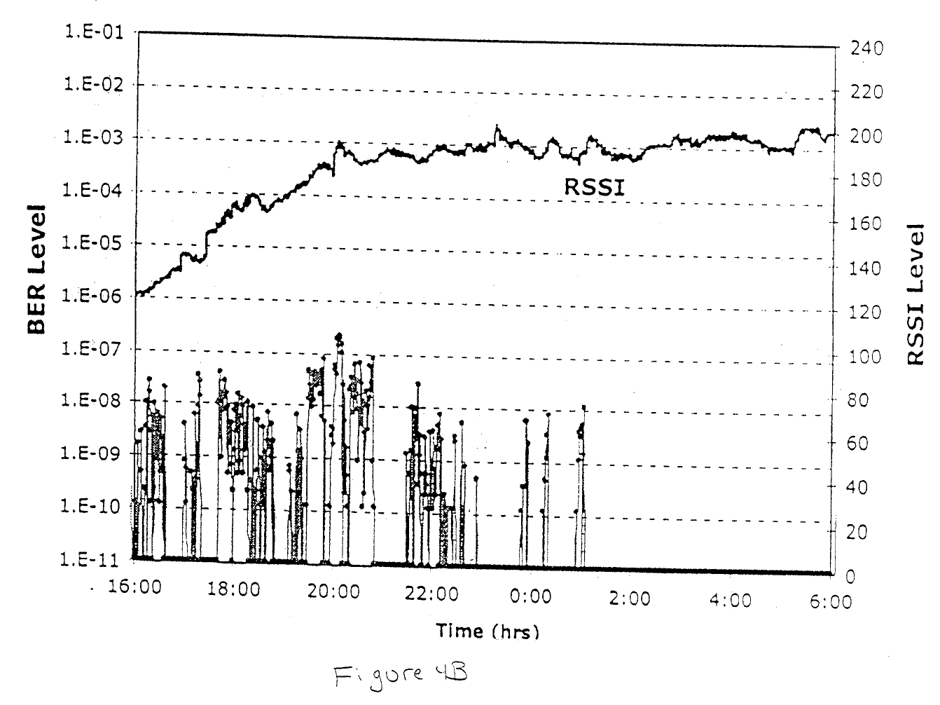

FIGS. 4A and 4B demonstrate the advantages of using real-time BER statistics for the monitoring the end-to-end performance statistics rather than the use of real-time RSSI values. FIGS. 4A and 4B depict data plotted and recorded during in-field experimentation. FIGS. 4A and 4B indicate that RSSI is not a good indicator of end-to-end optical wireless channel performance and hence can not be used to reliably characterize the wireless link performance. For example, in FIG. 4A, the recorded RSSI level is higher in the evening-midnight section, 18:00 to 0:00 as compared to the level during that afternoon, 12:00-16:00. Essentially, the wireless link performance actually degrades, i.e. BER increases, instead of improving as one would expect with the increase in RSSI. Similarly, in FIG. 4B, during evening hours, 16:00-20:00, the BER performance of the channel remains relatively unaffected despite of significant increase in the RSSI levels. As a matter of fact, the distinct lack of consistency between RSSI values and the corresponding wireless channel BER performance is clearly indicated by the sudden improvement in BER towards early morning. 2:00-6:00, despite of negligible change in the RSSI values. These FIGS. 4A and 4B show that real-time RSSI values do not describe the state of a wireless channel accurately/reliably and hence real-time BER statistics are preferably used to characterize the wireless channel performance. Therefore, the real-time BER statistics are preferably used to initiate the actions in the wireless link maintenance sub-system 116, WCMS.

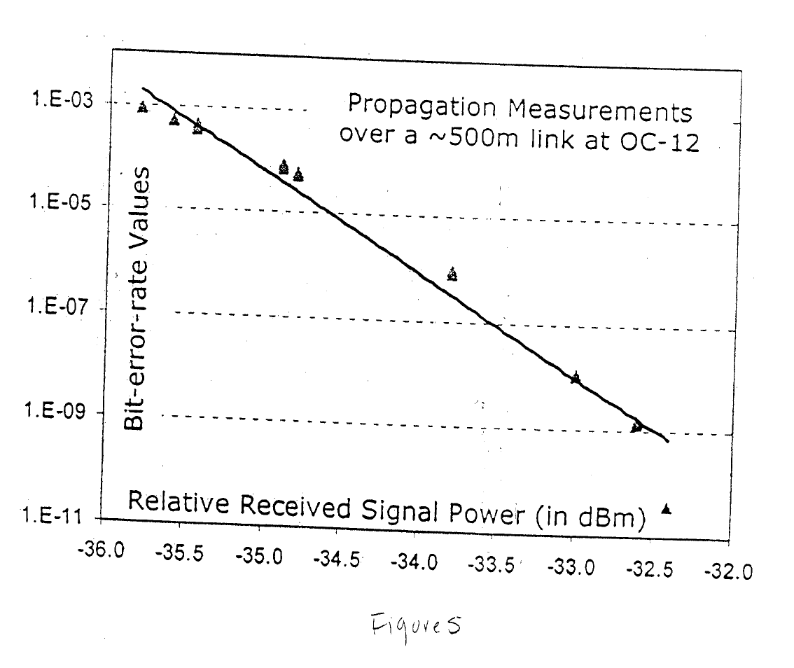

One of the dynamic link maintenance schemes implemented and experimentally evaluated was dynamic system power control. FIG. 5 shows the experimental evaluation results characterizing the performance of the system. Relative Received Signal Power (in dBm) and corresponding BER values are plotted against each other in the FIG. 5. The experiment was performed at a given/fixed data rate of OC-12 and FIG. 5 can be interpreted as follows—for the FSOW link, operating at OC-12 data rate, it is possible to improve the QoS (BER) performance to desired levels by increasing the received signal power accordingly. For example, for about 2 dB of increase in received signal power, the BER performance of the system can be improved by four orders of magnitude. Another way to interpret FIG. 5 would be, any increase in atmospheric attenuation or deterioration in BER performance of the system, during adverse weather events, can be mitigated by increasing the effective received signal power in accordance with the data in FIG. 5.

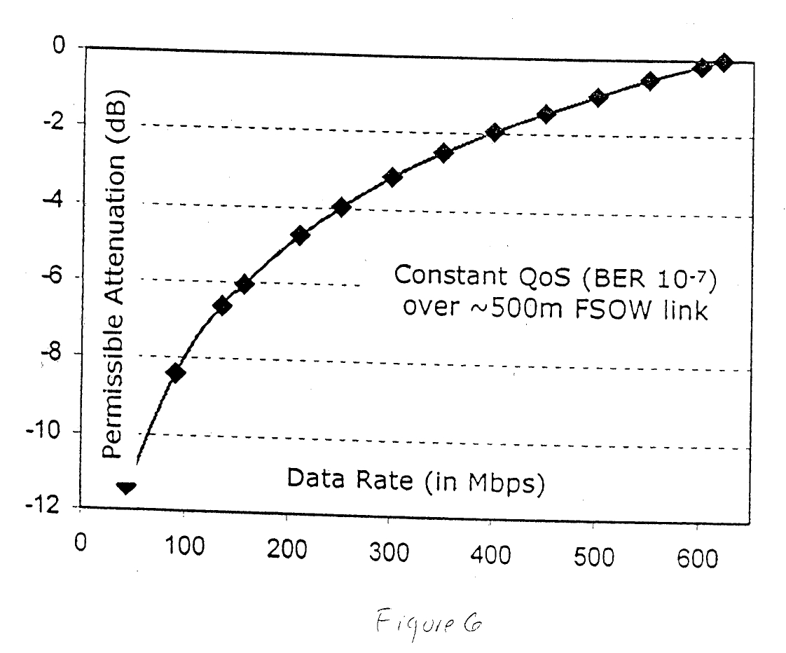

Another dynamic link maintenance scheme implemented and experimentally evaluated was dynamic rate control. FIG. 6 depicts the experimental evaluation result characterizing the performance of the filed test bed. Data rate values (in Mbps) and corresponding permissible attenuation values are plotted against each other in FIG. 6. The experiment was performed at a given/fixed BER performance level of 10⁻⁷. FIG. 6 can be interpreted as follows, for the FSOW system it is possible to mitigate any increase in atmospheric attenuation and maintain the desired level of QoA by appropriately changing the data rates in accordance with the data in FIG. 6.

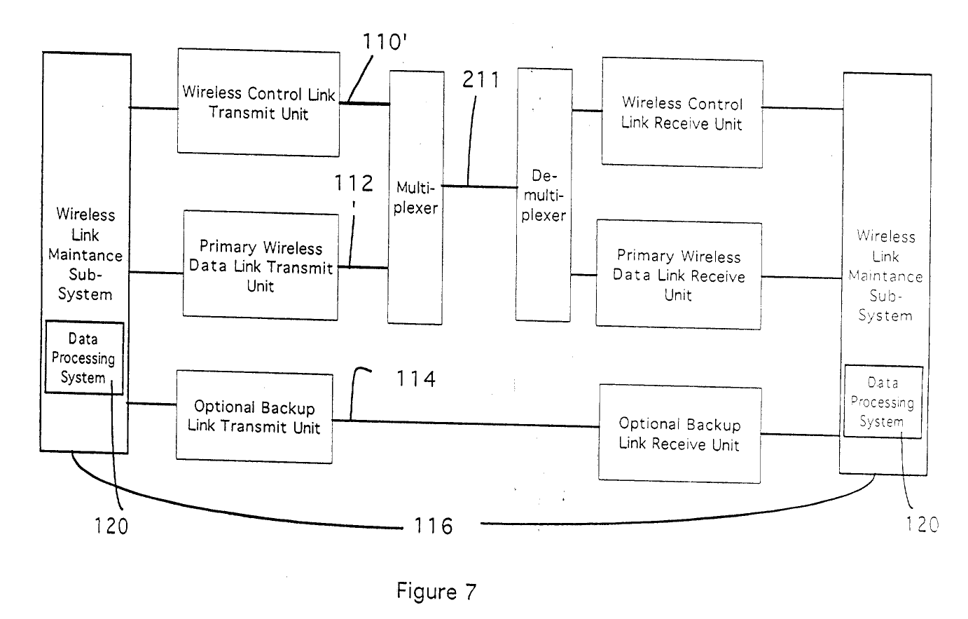

FIG. 7 depicts another embodiment of the present invention in which the Wireless control link 110′ is integrated into the primary wireless data link 112′, and the two links are sent together over the wireless channel 211. One method for integrating the wireless control link 110′ into the primary wireless data link 112′ is by exploiting time-multiplexing techniques for real-time link performance monitoring. This embodiment provides a cost-effective alternative. One skilled in the art will appreciate that there are many methods of integrating the wireless control link 110′ onto the primary data link 112′.

Referring to the embodiment in FIG. 1, one advantage associated with the separate wireless control link scheme is that the wireless control link 110 can evaluate all the available corrective action options sequentially in real-time and allow the wireless link maintenance sub-system 116 to identify the best solution. The wireless link maintenance sub-system 116 can anticipate impending deterioration in performance of the primary wireless data link 112 well in advance by monitoring the performance of the wireless control link 110. Consequently, there is sufficient time for the wireless link maintenance sub-system 116 to evaluate all the available options on the wireless control link 110 and identify the best one before the actual performance of the primary wireless data link 112 is affected. Since the wireless link maintenance sub-system 116 preferably intelligently choose the best solution for a given scenario by real-time evaluation, the independent control link architecture also improves the overall efficiency of the link protection scheme.

One skilled in the art will appreciate that the embodiments in FIG. 1 and FIG. 7 may be used at different times depending upon the needs and requirements of the wireless system deployed. For example, an independent wireless control link, as shown in FIG. 1, can monitor the wireless channel continuously. In the time-division-multiplexing based architecture, as shown in FIG. 7, the wireless control link 110′ and primary wireless data link 112′ use the same wireless channel 211 on a time-shared basis and typically the wireless control link 110′ is allocated a relatively small duration of the frame time. Consequently, the channel performance metrics calculated from the intermittently measured data points may not be accurate. On the other hand, a separate, independent wireless control link 110 can record data continuously and accurately characterize any change in link performance due to weather changes. The independent wireless control link 110 of FIG. 1 will not only improve the short-term forecasting abilities of the wireless link maintenance sub-system 116, but also improve the response time, the availability statistics and the overall performance of the network.

As mentioned above, despite of deteriorating circumstances, a device monitoring the primary wireless data channel 112 with built-in link margin will fail to take proactive measures. On the other hand, the performance of the no-margin independent wireless control link 110 can serve as a precursor to the future condition of the primary wireless data link 112 and thus facilitate identification and initiation of restorative actions. The same is the case when dynamic power control or other corrective schemes kick-in to restore the primary wireless data link performance and a monitoring device on the primary wireless data link 112 will fail to detect any weather fluctuations. Such a ‘primary link monitoring’ based configuration will cause unwarranted increase in the wireless link maintenance sub-system 116 response time. Finally, an independent wireless control channel 110 will help enable the evaluation of the effectiveness of all available options/solutions to mitigate increased signal attenuation since more time is available to test different mitigating responses to the degradation. One skilled in the art will appreciate that different coding, error correction, and modulation schemes provide different performance improvements during different channel conditions, which might be caused by different weather events. For example, during adverse events, the data rate can be reduced to increase bit duration and consequently increase energy-per-bit. As a second option, the overall data rate may be maintained the same while introducing stronger error correction schemes. In both cases, the information transfer rate is reduced but one scheme may perform better than the other in specific circumstances. Similarly, for non-real time applications, multi-hop routing may be the best alternative in a given scenario. Consequently, in an ideal system, the wireless link maintenance sub-system 116 will be required to implement, evaluate, and choose in real-time the most efficient and effective solution to achieve desired results. An independent wireless control link 110 is preferable for such efficient fault tolerant architecture.

### Possible Deployments

In one deployment environment as shown in FIG. 8, next generation high-speed FSOW based networks will have mesh configurations and majority of FSOW links in these networks will be short distance links; robust in nature and consequently weather independent. Hence there will be no need to monitor the performance of these short-distance links. Instead, resources will be allocated to monitoring, and proactive management of long distance links. Independent wireless control link architecture will obviate the need to develop expensive generic laser modules with built-in link performance monitoring and management functionality, thereby lowering the cost of generic equipment. Thus, for the short distance links, only the primary wireless data link 501 will be provided. However, for the long distance links, both the primary wireless data link 501 and a wireless control data link 502 will be provided. Thus, the expense of having a control link is only undertaken when the link is susceptible to large channel variations, that can be proactively monitored.

As mentioned above, this wireless control link architecture may be utilized in a Hybrid FSOW/RF system. The FSOW and RF sub-systems are placed parallel to each other. Current state-of-the-art FSOW systems are capable of data rates on the order of 160 Gbps using WDM. The RF systems that mostly operate in the 5.4 GHz, 28 GHz (licensed), or 38 GHz (unlicensed) frequency bands can sustain up to OC-12 (622 Mbps) data rates. During clear sky conditions, these RF channels can be used to augment the overall data capacity of FSO channels or take over the entire traffic (as much as possible) when FSO experiences total outage. The system can be specifically designed to effect traffic transition automatically and in incremental steps during upcoming adverse weather conditions.

The hybrid architecture is preferably designed and integrated that in the event of adversities, it automatically regulates all the RF links in to a hot standby mode followed by automatic switching of data traffic from FSOW to RF as soon as the FSOW link experiences outage. This can be easily achieved using requisite hardware and appropriate software. The system hardware can be configured to monitor the performance of the FSOW link in real-time, continuously The system software can be customized to record the performance statistics followed by parameter processing to derive desired metrics such as average bit-error-rate (BER) or average received-signal-strength (RSS). These metrics can be then used to make appropriate decisions for transfer of data from FSOW to RF channels. In hardware, the data traffic switching can be accomplished by using an optical switch controlled by a feedback mechanism.

The proposed data traffic switching can be performed in incremental steps to ensure high overall functional efficiency. This leads to added complexity in the software and hardware but can provide significant gains over a long duration. For more information about hybrid architecture and the load partitioning see U.S. Provisional Patent Application No. 60/399,659 mentioned above and entitled “Method and Apparatus for Load Switching in Hybrid RF/Free Space Optical Wireless Links” incorporated herein by reference. Also, see U.S. application Ser. No. 09/800,917 entitled “Hybrid RF and Optical Wireless Communication Links” and network structures incorporating it therein which is also incorporated herein by reference.

The FSOW technology is well-suited for short distance as well as long distance point-to-point or point-to-multipoint applications. Though we have an elaborate fiber backbone infrastructure, only five percent of the establishments are connected directly to the backbone through high-capacity fiber. The statistics also indicate that 95 percent of the remaining commercial establishments are only about a mile from the fiber' backbones or its offshoots. While wiring (using fiber) all these establishments to extend ‘true’ high-speed data access is a possibility, it is an exorbitantly expensive preposition. The multi-Gbps data carrying capacity of the FSOW systems makes them the most economically viable and secure solution for point-to-point or point-to-multipoint deployments. Rapid deployment is another important characteristic of FSOW systems that can significantly facilitate deployment of next-generation high-speed ‘mesh-like’ networks in urban and semi-urban environments. In these next-generation, free-space last mile data access, or long-range backbone connectivity networks, the hybrid architecture will play a vital role in ensuring carrier-grade reliability and availability. FIG. 8 shows a sample high-speed hybrid network.

FIG. 8 shows a high-speed hybrid network that connects several establishments in an urban environment. The ‘mesh-like’ design provides the desired redundancy and allows multi-hop routing (alternate path) over shorter length links during adverse weather conditions. It must be noted that many of the shorter FSOW links are not ‘backed-up’ by RF links. This is due to the fact that these short links will have enough built-in power margins to mitigate atmospheric adversities. On the other hand, several of the relatively longer distance links have built-in hybrid functionality so that in the event of an FSOW outage, the RF link can be used to sustain connectivity, although relatively at a much lower data rate.

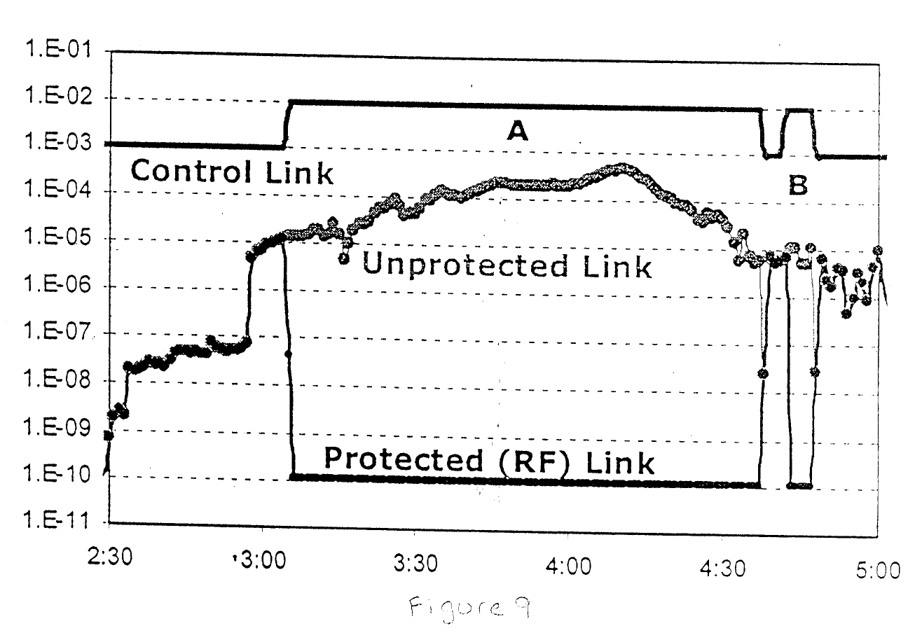

As mentioned above, the FSOW system performance deteriorates significantly during moderate to heavy fog and mist conditions. The system can also experience total outage during dense fog events when the attenuation introduced by fog particulates is as high as 300 dB/km. Since RF systems are unaffected by fog conditions, the hybrid system architecture exploits FSOW and RF system operating in parallel with each other while complementing each other's performance during adverse weather conditions. Though, dynamic power control and dynamic data rate control can reinforce the FSOW link performance and mitigate moderate system performance deterioration, during extreme weather conditions, the data traffic must be dynamically switched from FSO to RF media. This is known as dynamic load switching (DLS). A computer controlled optical traffic switch, is used to effect the transition. The switching decision is made based on the average BER performance metric calculated from real-time BER values recorded by the channel performance monitoring sub-system. During these experiments, the QoS threshold was preset at 10⁻⁵ under the assumption that error correction coding and other link reinforcing schemes can easily improve the end-to-end QoS performance to better than 10⁻⁹. The experimental performance of hybrid architecture is as shown in FIG. 9.

It is evident from FIG. 9 that the performance of FSOW link starts deteriorating with the gradual buildup of the fog. The data traffic (protected link) continues to flow through the FSOW link despite of deteriorating BER performance until the threshold level of 10⁻⁵, is breached. As soon as the pre-defined QoS threshold level is breached, the data traffic is promptly switched over to the RF link. The control signal and corresponding event A indicate this transition to RF. Error-free data transmission during event A in the figure clearly shows that RF link is not affected by fog.

Also, note that with the clearing of fog, as the performance of the FSOW link improves, the link is automatically restored. During this event (between A and B), although RF link has better QoS, the data traffic is switched back to FSOW to facilitate the possibility of data transmission at higher rates. During event B, when dense fog again rolls in, the data traffic is again routed through the RF for a couple of minutes before automatic restoration to FSOW. The figure, therefore, successfully demonstrates the functionality/effectiveness of the architecture.

### SUMMARY

The disclosed system, which utilizes a wireless control link 110, has many advantages over current wireless system technologies. The wireless control link 110 provides for independent full-duplex (closed loop) control channel functionality preferably based on end-to-end bit-error-rate (rather than RSSI) for accurate wireless channel characterization in given operating atmospheric conditions (such as rain, fog, snow etc). The independent control channel 110 functionality allows for the prediction of changes in operating atmospheric conditions and their effects on the primary wireless data link in advance of degradation of the primary wireless data link. In addition to being proactive, the wireless control channel 110 can be used to evaluate various possible corrective actions which allows for the mitigation of impending deterioration in performance of the primary wireless data link 112 and selection of the best alternative for any given scenario. Further, the wireless control link 10 imparts dynamic adaptability to operating conditions which eliminates the need to design for, and operate the system at, worst-case scenario levels to ensure long-term unattended operation. In other words, dynamic adaptability enhances overall efficiency. Additionally, the automated and intelligent dynamic adaptability eliminates the need to accurately characterize absolute weather conditions.

From the foregoing description, it will be apparent that the present invention has a number of advantages, some of which have been described herein, and others of which are inherent in the embodiments of the invention described herein. Also, it will be understood that modifications can be made to the method and apparatus described herein without departing from the teachings of the subject matter described herein. As such, the invention is not to be limited to the described embodiments except as required by the appended claims.

What is claimed is:

1. An apparatus for proactively sustaining a wireless link comprising:
a primary wireless data link;
a wireless control link; and
a wireless link maintenance sub-system including a data processing system for maintaining the primary wireless data link by monitoring a set of parameters associated with the wireless control link, wherein the wireless link maintenance sub-system utilizes the monitored parameters associated with the wireless control link to proactively evaluate a set of possible actions, and select the best action from the set of possible actions.

2. The apparatus of claim 1 wherein said primary wireless data link is separate and independent from said wireless control link.

3. The apparatus of claim 1 wherein said wireless control link is multiplexed with said primary wireless data link, and a transmitter is used to transmit both said wireless control link and said primary wireless data link.

4. The apparatus of claim 1 wherein said primary wireless data link and said wireless control link are free space optical wireless links.

5. The apparatus of claim 1 further comprising a back-up wireless data link.

6. The apparatus of claim 5 wherein said back-up wireless data link is a radio frequency data link.

7. The apparatus of claim 1 wherein the set of parameters associated with the primary wireless data link and the wireless control link includes bit error rate.

8. The apparatus of claim 1 wherein the set of possible actions includes changing a coding scheme on the primary wireless data link, changing a error correcting scheme for the primary wireless data link, changing a power level on the primary wireless data link, or changing a data rate on the primary wireless data link or changing a modulation scheme on the primary wireless data link.

9. A method for maintaining a wireless connection comprising the steps of:
monitoring a set of performance parameters of a wireless control link;
evaluating a set of possible actions based on said set of performance parameters; and
implementing on a wireless primary data link a best action from said set of possible actions.

10. The method of claim 9 wherein said primary wireless data link is separate and independent from said wireless control link.

11. The method of claim 9 further comprising the steps of:
multiplexing said wireless control link with said primary wireless data link; and
transmitting both said wireless control link and said primary wireless data link over a common channel.

12. The method of claim 9 wherein said primary wireless data link and said wireless control link are free space optical wireless links.

13. The method of claim 1 further comprising the step of providing a back-up wireless data link.

14. The method of claim 13 wherein said back-up wireless data link is a radio frequency data link.

15. The method of claim 9 wherein the set of monitored performance includes bit error rate.

16. The method of claim 9 wherein the set of possible actions includes changing a coding scheme on the primary wireless data link, changing a error correcting scheme for the primary wireless data link, changing a power level on the primary wireless data link, or changing a data rate on the primary wireless data link or changing a modulation scheme on the primary wireless. data link.

17. An system comprising:
an optical data link;
an optical control link;
a link maintenance sub-system, wherein in said link maintenance sub-system monitors a bit-error rate of the optical control link and changes parameters associated with the optical data link to prevent the optical data link from exceeding a given bit-error rate.

18. The system of claim 17 wherein the optical control link has a lower associated power than a power associated with the optical data link.

19. The system of claim 17 wherein the link maintenance sub-system changes parameters associated with the optical control link to evaluate the changes before changing parameters associated with the optical data link.

20. An apparatus for sustaining fixed wireless links during varying channel conditions, the apparatus comprising:
an input for receiving link-performance information regarding at least one control link;
a data processing system for receiving the link-performance information from the input and for processing the link-performance information to determine at least one data link adjustment for adjusting parameters of at least one data link based on the performance information; and
an output for outputting the data link adjustment for use in adjusting the parameters of the data link

21. An apparatus for sustaining fixed wireless links during adverse operating conditions, as set forth in claim 20, wherein the data processing system further comprises a set of rules for mapping the link-performance information to a data link adjustment.

22. An apparatus for sustaining fixed wireless links during adverse operating conditions, as set forth in claim 21, wherein the data processing system further comprises a predictor for predicting likely further degradation of operating conditions based on past link-performance information, and wherein the data processing system modifies the link adjustment based on the likely further degradation.

23. An apparatus for sustaining fixed wireless links during adverse operating conditions, as set forth in claim 22, wherein the data processing system further receives weather-related forecasts, and modifies the link adjustment based on the likely future operating conditions from the weather-related forecasts.

24. An apparatus for sustaining fixed wireless links during adverse operating conditions, as set forth in claim 21, wherein the rules for mapping the link-performance information are based on mapping bit-rate errors of the control link for a given set of operating conditions to data link adjustments minimize bit-rate errors in the data link for the same set of operating conditions, whereby the control link is used as an indirect gauge for determining appropriate data link adjustments.

25. An apparatus for sustaining fixed wireless links during adverse operating conditions, as set forth in claim 20, wherein the apparatus further comprises an output for outputting the data link adjustment to a control link for use in adjusting the parameters on the control link in order to determine whether the data link adjustment is effective prior to adjusting the parameters of the data

26. An apparatus for sustaining fixed wireless links during adverse operating conditions, as set forth in claim 20, wherein the data processing system further comprises a means for adjusting parameters of the control link to adjust the sensitivity of the control signal to operating condition variations.

27. An apparatus for sustaining fixed wireless links during adverse operating conditions, as set forth in claim 26, wherein the data processing system further comprises a means for adjusting the parameters of the control link to adjust the sensitivity of the control signal to cyclical operating condition variations.

28. An apparatus for sustaining fixed wireless links during adverse operating conditions, as set forth in claim 20, wherein the data link adjustment includes information for adjusting data link parameters including transmission power, transmission data rate, and load sharing.

29. An apparatus for sustaining fixed wireless links during adverse operating conditions, as set forth in claim 20, wherein the link-performance information includes bit-error rate statistics for the control link.

30. An apparatus for sustaining fixed wireless links during adverse operating conditions, as set forth in claim 29, where the bit-error statistics are an average bit-error rate over a time window.
